(19) United States
(12) Patent Application Publication
(10) Pub. No.: US 2020/0008437 A1
(43) Pub. Date: Jan. 9, 2020

(54) STARTER CULTURE CONTAINING MIXTURE OF LACTIC ACID BACTERIA STRAINS, AND FERMENTED PRODUCT PREPARED USING SUCH STARTER CULTURE AND USE OF THIS FERMENTED PRODUCT

(71) Applicant: SYNBIO TECH INC., KAOHSIUNG CITY (TW)

(72) Inventors: Chi-Chang HUANG, Taoyuan City (TW); Jin-Seng LIN, Tainan City (TW)

(21) Appl. No.: 16/259,238

(22) Filed: Jan. 28, 2019

Related U.S. Application Data
(60) Provisional application No. 62/694,202, filed on Jul. 5, 2018.

(51) Int. Cl. A23C 9/12; A23L 33/135

(52) U.S. Cl. CPC A23C 9/1203; A23L 33/135; A23V 2200/31; A23V 2300/10; A23V 2300/20; A23V 2002/00

(57) ABSTRACT

Disclosed herein are a starter culture and a fermented product prepared using such starter culture. The starter culture comprises a mixture of Lactobacillus fermentum strain LF26, Lactobacillus helveticus strain LH43, Lactobacillus paracasei strain LPC12, Lactobacillus rhamnosus strain LRH10, and Streptococcus thermophilus strain ST30. Also disclosed herein are methods for reducing fatigue, improving exercise performance, and/or modifying gut microbiota. Each of these methods includes administering to a subject the fermented product.

### CROSS-REFERENCE TO RELATED APPLICATION

This application claims priority of U.S. Provisional Application No. 62/694,202, filed on Jul. 5, 2018.

### FIELD

The present disclosure relates to a starter culture containing a mixture of particular lactic acid bacteria strains, and a fermented product prepared using such starter culture as well as use of this fermented product.

### BACKGROUND

Fermented milk drinks, such as yogurt, yakult, and kefir, are drinks containing nutrients and probiotics. Probiotics are microorganisms that can provide health benefits generally by improving or restoring the gut flora. It has been found that adverse changes in the gut microbiota composition might cause several diseases and disorders, for instance, myalgic encephalomyelitis/chronic fatigue syndrome (ME/CFS), immune dysfunction in ME/CFS patients, a significant increase of lactic acid in ME/CFS patients, and so forth. Therefore, fermented milk drinks are used to modify the gut microbiota composition and to improve physiological conditions associated therewith.

In addition to the fatigue caused by adverse changes in the gut microbiota composition, during exercise, many energy sources (e.g., glucose and glycogen) are exhausted, resulting in physical fatigue which can be evaluated based on several biochemical indices such as lactate, ammonia, blood urea nitrogen (BUN), glucose, creatine kinase (CK), etc. In particular, strenuous exercise can lead to the accumulation of reactive oxygen species and lipid peroxides, thereby damaging the organs and causing fatigue. Since probiotics can have a positive effect on athletic performance by enhancing recovery from fatigue, fermented milk drinks may relieve physical fatigue arising from exercises.

Kefir, which originates from the Caucasus Mountains, is an acidic fermented milk beverage with trace amounts of alcohol. Kefir is traditionally produced by inoculating milk (from cows, goats, sheep, camels, or buffalos) with a relatively stable and specific Kefir grain (a starter culture), which contains lactic acid bacteria and yeast, in a goat skin bag, a clay pot, or a wooden bucket, and subsequently by conducting fermentation for about 1 day at room temperature. Such beverage has become an important functional dairy product, and has been used for the clinical treatment of gastrointestinal diseases, hypertension, ischemic heart disease, and allergies. In addition, kefir possesses many biological activities, including antibacterial, antifungal, antimutagenic, antioxidant, antidiabetic, antitumor, and immune-stimulating effects, as well as an effect against fatty liver syndrome. Numerous bacteria and yeasts have been randomly isolated from kefir grains and from the fermented kefir product for use in starter cultures. However, since the composition in conventional starter cultures for preparing kefir, which are normally obtained from traditional kefir, might vary from time to time and place to place and be hardly fully identified, the quality of the kefir produced cannot be consistently satisfactory.

In developing a fermented product containing probiotics, the applicant has unexpectedly found that a mixture of various lactic acid bacteria strains identified from kefir can be used to consistently prepare a fermented product having excellent anti-fatigue ability and capable of modifying the gut microbiota composition, as well as exhibiting an exercise performance enhancing effect.

### SUMMARY

Accordingly, in a first aspect, the present disclosure provides a starter culture for preparing a fermented product, which includes a mixture of the following five lactic acid bacteria strains deposited at Deutsche Sammlung von Mikroorganismen und Zellkulturen GmbH:
Lactobacillus fermentum strain LF26 with Accession No. DSM 32784, Lactobacillus helveticus strain LH43 with Accession No. DSM 32787, Lactobacillus paracasei strain LPC12 with Accession No. DSM 32785, Lactobacillus rhamnosus strain LRH10 with Accession No. DSM 32786, and Streptococcus thermophilus strain ST30 with Accession No. DSM 32788.

In a second aspect, the present disclosure provides a process for preparing a fermented product, which includes subjecting a fermentable material to a fermentation treatment with a starter culture as mentioned above.

In a third aspect, the present disclosure provides a fermented product which is prepared by a process as described above.

In a fourth aspect, the present disclosure provides a method for reducing fatigue, which includes administering to a subject a fermented product as described above.

In a fifth aspect, the present disclosure provides a method for improving exercise performance, which includes administering to a subject a fermented product as described above.

In a sixth aspect, the present disclosure provides a method for modifying gut microbiota, which includes administering to a subject a fermented product as described above.

### BRIEF DESCRIPTION OF THE DRAWINGS

Other features and advantages of the disclosure will become apparent in the following detailed description of the embodiments with reference to the accompanying drawings, of which:

FIG. 1 shows the effect of the fermented product of the present disclosure at different dosages on the swimming time (minutes), in which the symbol “#” represents p<0.05 (compared with the vehicle control group, which is abbreviated as vehicle group);

FIG. 2 shows the effect of the fermented product of the present disclosure at different dosages on the forelimb grip strength (grams), in which the symbol “#” represents p<0.05 (compared with the vehicle group);

FIGS. 3A and 3B respectively show the effect of the fermented product of the present disclosure at different dosages on the serum lactate level (mmol/L) after a 10-minute swimming exercise and before a 20-minute rest, and after the 20-minute rest, in which the symbol “#” represents p<0.05 (compared with the vehicle group);

FIGS. 4A and 4B respectively show the effect of the fermented product of the present disclosure at different dosages on the serum ammonia level (μmol/L) after a 10-minute swimming exercise and before a 20-minute rest, and after the 20-minute rest, in which the symbol “#” represents p<0.05 (compared with the vehicle group);

FIG. 5 shows the effect of the fermented product of the present disclosure at different dosages on the blood urea nitrogen (BUN) level in serum (mg/dL) after a 90-minute swimming exercise and a 60-minute rest, in which the symbol “#” represents p<0.05 (compared with the vehicle group);

FIG. 6 shows the effect of the fermented product of the present disclosure at different dosages on the creatine kinase (CK) level in serum (U/L) after a 90-minute swimming exercise and a 60-minute rest, in which the symbol “#” represents p<0.05 (compared with the vehicle group); and

FIGS. 7A and 7B respectively show the effect of the fermented product of the present disclosure at different dosages on the liver glycogen content (mg/g liver) and muscle glycogen content (mg/g muscle), in which the symbol “#” represents p<0.05 (compared with the vehicle group), and the symbol “*” represents p<0.05 (compared with the 1× and 2× groups).

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

Through research, the applicant suprisingly found that a mixture of particular lactic acid bacteria strains isolated from traditional kefir can be used to prepare a fermented product having excellent anti-fatigue ability and capable of modifying the gut microbiota composition.

Therefore, the present disclosure provides a starter culture for preparing a fermented product, which comprises a mixture of the following five lactic acid bacteria strains (deposited at Deutsche Sammlung von Mikroorganismen und Zellkulturen GmbH, Inhoffenstreet 7B, 38124, Braunschweig, Lower Saxony, Germany): Lactobacillus fermentum strain LF26 (Accession No. DSM 32784; date of deposit: Apr. 3, 2018), Lactobacillus helveticus strain LH43 (Accession No. DSM 32787; date of deposit: Apr. 3, 2018), Lactobacillus paracasei strain LPC12 (Accession No. DSM 32785; date of deposit: Apr. 3, 2018), Lactobacillus rhamnosus strain LRH10 (Accession No. DSM 32786; date of deposit: Apr. 3, 2018), and Streptococcus thermophilus strain ST30 (Accession No. DSM 32788; date of deposit: Apr. 3, 2018).

As used herein, the term “starter culture” refers to a composition comprising live microorganisms that are capable of initiating or effecting fermentation of an organic material, optionally after being cultivated in a separate or same starter medium for obtaining a high density culture. The starter culture may further contain an additional microorganism other than the five lactic acid bacteria strains mentioned above, such as Lactobacillus casei, Lactobacillus plantarum, Lactobacillus acidophilus, Lactobacillus brevis, Lactobacillus bulgaricus, Lactobacillus delbrueckii ssp. lactis, Lactobacillus gasseri, Lactobacillus johnsonii, Lactobacillus kefir, Lactobacillus kefiranofaciens, Lactococcus lactis, Lactococcus cremoris, Leuconostoc mesenteroides, Kluyveromyces marxianus, Saccharomyces cerevisiae.

According to the present disclosure, the starter culture may be concentrated or non-concentrated, a liquid, apaste, a semi-solid, or a solid (e.g. a pellet, a granule, or a powder), and may be frozen, dried, or freeze-dried (for example, may be in freeze-dried form or spray/fluid bed dried form). In some embodiments, the starter culture is in dried powder form.

According to the present disclosure, the starter culture may also contain, in addition to the microorganisms, a cultivation medium, such as milk, soy milk, whey, casein, yeast extract, grains, seeds, or nutrient liquids. Moreover, the starter culture may also contain, in addition to the microorganisms, buffering agents and growth stimulating nutrients (e.g., an assimilable carbohydrate or a nitrogen source), or preservatives (e.g., cryoprotective compounds) or other carriers, if desired, such as sugars.

Furthermore, the present disclosure provides a process for preparing a fermented product, which comprises subjecting a fermentable material to a fermentation treatment with the aforesaid starter culture. The present disclosure also provides the fermented product prepared by such process.

The term “fermentable material” refers to a material that can undergo fermentation by the microorganisms in the starter culture.

According to the present disclosure, the fermentable material may be, for example, a dairy material, a soybean material, a rice material, a nut material, a coconut material, a fruit material, a beer wort material, or a ginger material. In some embodiments, the fermentable material is a dairy material. Examples of the dairy material include, but are not limited to, milk, whey, fermented milk, a lactic acid bacterium drink, skim milk, powdered skim milk, prepared powdered milk, powdered milk, concentrated milk, concentrated skim milk, reconstituted skim milk, condensed milk, condensed skim milk, sweetened condensed milk, sweetened condensed skim milk, etc. In an exemplary embodiment, the fermentable material is reconstituted skim milk.

When the fermentable material is a dairy material, the fermented product thus obtained may be, for instance, kefir, yogurt, buttermilk, soured cream milk, soured milk, fermented whey, and quark.

According to the present disclosure, the fermentation treatment may be conducted at 30° C. to 43° C. for 8 to 24 hours. In an exemplary embodiment, the fermentation treatment is conducted at 37° C. for 16 hours.

According to the present disclosure, the fermented product prepared by the aforesaid process may be in the form of a liquid, a paste, a semi-solid, or a solid (e.g. a pellet, a granule, or a powder), and may be frozen, dried, or freeze-dried (for example, may be in freeze-dried form or spray/fluid bed dried form).

According to the present disclosure, the aforesaid process may further comprise conducting a dehydration treatment after the fermentation treatment, so that the fermented product prepared by such process may be in dried form. Examples of the dehydration treatment include, but are not limited to, freeze-drying, fluidized bed drying, spray bed drying, drying under reduced pressure, hot-air drying, fluidized bed granulation, etc. In an exemplary embodiment, the fermented product of the present disclosure is in freeze-dried form.

The fermented product of the present disclosure may be used in various fields such as pharmaceuticals, health foods, processed foods, dietary supplements, etc. And there is no particular limitation in the form, so the fermented product may be used in a form of preparation such as aseptic power, tablets, troches, lozenges, pellets, capsules, dispersible powder or granule, solutions, suspensions, emulsions, syrup, elixir, slurry, jelly, etc, as those can be prepared by methods known in public appropriately. Furthermore, the fermented product of the present disclosure may be also used as an ingredient in various foods or drinks.

It was verified in the examples below that the fermented product prepared by the aforesaid process is able to improve fatigue-associated biochemical indices, enhance exercise endurance and grip strength, and modify the gut microbiota composition. Thus, the present disclosure provides the following use of such fermented product.

First, the present disclosure provides a method for reducing fatigue, which includes administering to a subject the fermented product described above.

The term “fatigue” refers to physical fatigue which arises from exercises, physical fatigue which is induced by intracellular glycogen accumulation, lactic acid dehydrogenase activity and citric acid synthase activity, physiological symptoms of diseases and disorders such as myalgic encephalomyelitis/chronic fatigue syndrome (ME/CFS), and so forth.

Secondly, the present disclosure provides a method for improving exercise performance, which includes administering to a subject the fermented product described above.

Exercise performance includes, but is not limited to, running speed and endurance, muscular strength and endurance, swimming speed and endurance, maximum muscle strength, lifting strength and endurance, pulling strength and endurance and throwing strength and endurance.

Thirdly, the present disclosure provides a method for modifying gut microbiota, which includes administering to a subject the fermented product described above.

According to the present disclosure, the dosage and frequency of administration of the fermented product for reducing fatigue, improving exercise performance, or modifying gut microbiota may vary depending on the following factors: the condition of the subject to be treated, the route of administration, and the desired effect (i.e. anti-fatigue effect, exercise performance improving effect, or gut microbiota modifying effect) to be achieved. For instance, the daily dosage of the fermented product of the present disclosure for oral administration may be 0.17 to 0.875 g/Kg body weight, and may be administered in a single dose or in several doses.

The disclosure will be further described by way of the following examples. However, it should be understood that the following examples are solely intended for the purpose of illustration and should not be construed as limiting the disclosure in practice.

### EXAMPLES

### Experimental Materials:

### 1. Test Animals

Male ICR (Institute of Cancer Research) mice (at the age of 6 weeks and having a weight of 25 g) were purchased from BioLASCO (a Charles River licensee corporation; Yi-Lan, Taiwan). The ICR mice were acclimatized at room temperature (24° C.±2° C.) and controlled humidity (65%±5%) under 12-hour light/12-hour dark cycles for two weeks. The ICR mice were provided with rodent chow 5001 (PMI Nutrition International, Brentwood, Mo., USA) and distilled water ad libitum. All the animal experiments described below were approved by the Institutional Animal Care and Use Committee (IACUC) of National Taiwan Sport University, and were compliant with the guidelines of protocol IACUC-10523.

### General Procedures:

### 1. Statistical Analysis

All the experimental data obtained in the examples below are expressed as mean±SD (standard deviation). Statistical analysis was conducted using a one-way analysis of variance (ANOVA) with Duncan's test (statistical significance is indicated by p<0.05). In addition, the Cochran-Armitage trend test was applied to examine the dose effect.

### Example 1. Preparation of Fermented Product of Present Disclosure from Various Lactic Acid Bacteria Strains in Combination

Five lactic acid bacteria strains, i.e. Lactobacillus fermentum strain LF26 (Accession No. DSM 32784), Lactobacillus helveticus strain LH43 (Accession No. DSM 32787), Lactobacillus paracasei strain LPC12 (Accession No. DSM 32785), Lactobacillus rhamnosus strain LRH10 (Accession No. DSM 32786), and Streptococcus thermophilus strain ST30 (Accession No. DSM 32788), were used to prepare a starter culture in powder form. 9.2% reconstituted skim milk, which was pasteurized, was inoculated with the starter culture, followed by fermentation at 37° C. for 16 hours. The resulting fermented milk served as a fermented product of the present disclosure.

The fermented product was then pasteurized at 100° C. for 30 minutes, and was freeze-dried. The freeze-dried fermented product, which contained, per 100 g thereof, 354.75 calories, 30 g of proteins, 0.75 g of fats, and 57 g of carbohydrates, was stored in an airtight container at 4° C.

### Example 2. Evaluation for Effects of Fermented Product of Present Disclosure on Fatigue Reduction and Exercise Performance, as Well as Biological and Biochemical Characteristics

In order to investigate whether the fermented product prepared from a combination of various lactic acid bacteria strains is effective in relieving fatigue, enhancing exercise performance, and improving biological and biochemical characteristics, the following experiments were conducted.

### A. Administration of Fermented Product of Present Disclosure

After the 2-week acclimation, the mice (turning to the age of 8 weeks) described in section A of Experimental Materials were divided into the following four groups (n=8 per group) based on their body weight: a vehicle control group (abbreviated as vehicle group), a single dosage group (abbreviated as 1× group), a two-fold dosage group (abbreviated as 2× group), and a five-fold dosage group (abbreviated as 5× group). The initial body weight of the mice was recorded. The freeze-dried fermented product obtained in Example 1 was orally administered to the mice of the 1×, 2×, and 5× groups at daily dosages of 2.15 g/kg body weight, 4.31 g/kg body weight, and 10.76 g/kg body weight, respectively. Specifically, the freeze-dried fermented product obtained in Example 1 was dissolved in water to form a fermented product solution for the oral administration through a tube. The mice of the vehicle group were orally administered with a suitable amount of a glucose water solution which had the same calorie content as the fermented product administered to the 1×, 2×, and 5× groups. The glucose water solution and the fermented product solution were orally administered at the same volume and once daily for 36 days (i.e. until the mice were sacrificed).

Before sacrifice of the mice described in section E of this example, the daily food and water intake of the mice was recorded.

### B. Exhaustive Swimming Test

The exhaustive swimming test was conducted 30 minutes after the administration of the fermented product solution or the glucose water solution on Day 29. Specifically, a respective one of the mice was placed in a columnar swimming pool (having a radius of 28 cm and a water depth of 25 cm) maintained at 27° C.±1° C. A weight load equivalent to 5% of the body weight was attached to the base of the tail of the respective mouse. The amount of time that the respective mouse spent on floating, struggling, and making movements to remain afloat (i.e. swimming status) until exhaustion and drowning was regarded as the swimming time (also referred to as the exhaustive swimming time). Exhaustion was determined by observing the respective mouse's failure to swim (i.e. by observing when the respective mouse was unable to remain on the water surface). The swimming time of the respective mouse was recorded from the beginning of the swimming status to the point of exhaustion, so as to evaluate endurance performance. The data obtained were subjected to statistical analysis according to the method described in section 1 of General Procedures.

### Results:

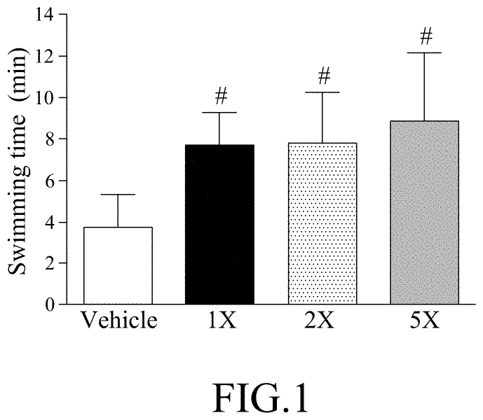

Referring to FIG. 1, the exhaustive swimming time of each of the 1×, 2×, and 5× groups was significantly longer than that of the vehicle group, indicating that the fermented product of the present disclosure can exhibit an anti-fatigue effect and hence can enhance the swimming endurance performance. Furthermore, a significant dose-dependent effect of the fermented product of the present disclosure on the swimming endurance performance (p<0.0001) was observed. Therefore, the fermented product of the present disclosure can improve exercise performance, particularly without the need to perform procedural exercise training and to additionally enhance nutrient availability.

### C. Forelimb Grip Strength Test

The forelimb grip strength (also referred to as forelimb absolute grip strength) of the respective mice was determined using a low-force testing system (Model-RX-5, Aikoh Engineering, Nagoya, Japan) 30 minutes after the administration of the fermented product solution or the glucose water solution on Day 28. Specifically, a force transducer equipped with a metal bar (having a diameter of 2 mm and a length of 7.5 cm) was used to measure the amount of the tensile force exerted by the respective mouse. During the measurement, the respective mouse was grasped at the base of the tail thereof, and was lowered vertically toward the bar. When the two paws of the respective mouse reached out to grasp the bar, the respective mouse was pulled slightly backward by the tail, which triggered a counter pull. The grasping force exerted by the respective mouse during the counter pull was measured and recorded in grams by the grip strength meter. The maximal grasping force was considered as the forelimb grip strength. The data obtained were subjected to statistical analysis according to the method described in section 1 of General Procedures.

### Results:

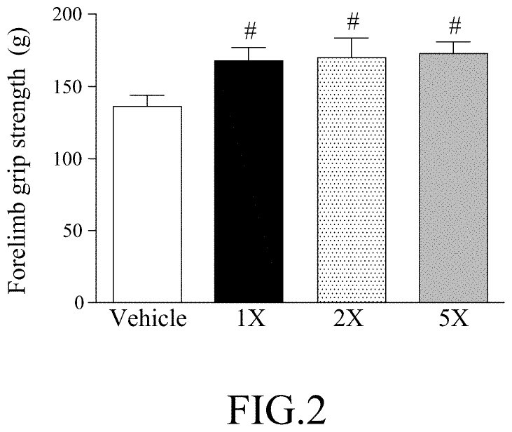

Referring to FIG. 2, the forelimb grip strength of each of the 1×, 2×, and 5× groups was significantly stronger than that of the vehicle group, indicating that the fermented product of the present disclosure can improve the grip strength and hence can enhance the muscle strength. In addition, a significant dose-dependent effect of the fermented product of the present disclosure on the grip strength (p<0.0001) was observed. Thus, the fermented product of the present disclosure is able to improve exercise performance, particularly without the need to perform procedural exercise training and to additionally enhance nutrient availability.

D. Determination of Fatigue-Associated Biochemical Indices after Non-Exhaustive Swimming Exercise

In order to examine the effects of the fermented product of the present disclosure on fatigue-associated biochemical indices after a swimming exercise other than the exhaustive swimming test performed in section B of this example, the following experiments were conducted.

### D-1. 10-Minute Swimming Exercise and 20-Minute Rest

On Day 31, a blood sample was collected from the respective mouse before and after a 10-minute swimming exercise, and after a 20-minute rest subsequent to the 10-minute swimming exercise. During the 10-minute swimming exercise, the respective mouse was placed in the columnar swimming pool used in section B of this example, and was allowed to swim without a weight load. The blood sample was subjected to centrifugation at 1,500 g and 4° C. for 10 minutes, followed by collecting the resulting supernatant which was serum. The lactate, ammonia, and glucose levels in the serum were determined using an autoanalyzer (Hitachi 7060, Hitachi, Tokyo, Japan).

The data obtained were subjected to statistical analysis according to the method described in section 1 of General Procedures.

### D-2. 90-Minute Swimming Exercise and 60-Minute Rest

Moreover, on Day 33, the respective mouse was subjected to a 90-minute swimming exercise and subsequently to a 60-minute rest, so as to evaluate fatigue-associated changes in the creatine kinase (CK) level and the blood urea nitrogen (BUN) level. During the 90-minute swimming exercise, the respective mouse was placed in the columnar swimming pool used in section B of this example, and was allowed to swim without a weight load. The CK and BUN levels in the serum were determined generally according to the aforesaid procedures for determining the lactate, ammonia, and glucose levels.

The data obtained were subjected to statistical analysis according to the method described in section

### 1 of General Procedures.

### Results:

### D-1. 10-Minute Swimming Exercise and 20-Minute Rest

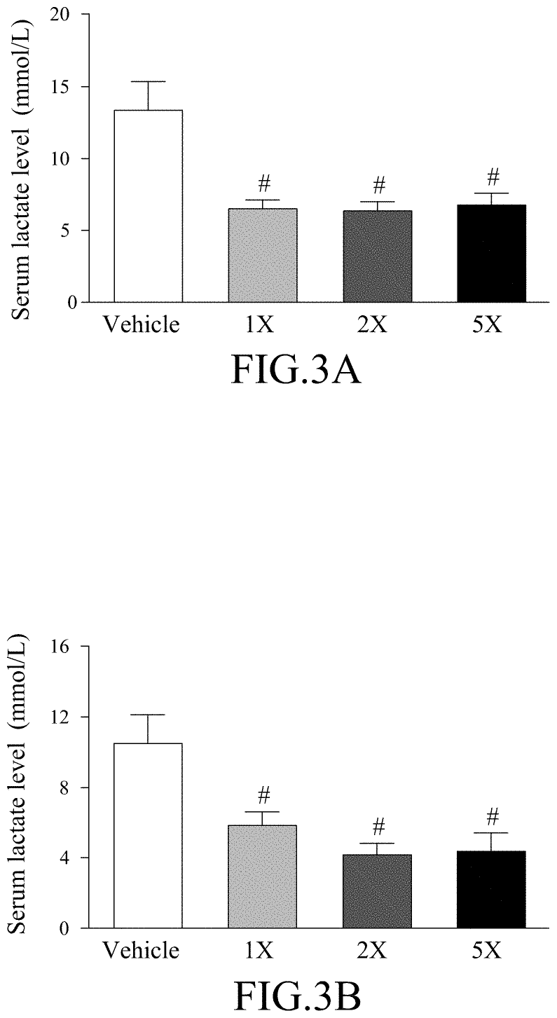

Before the 10-minute swimming exercise, no significant difference was observed on the blood lactate level among the vehicle, 1×, 2×, and 5× groups (data not shown). Referring to FIG. 3A, after the 10-minute swimming exercise and before the 20-minute rest, the serum lactate level of each of the 1×, 2×, and 5× groups was significantly lower than that of the vehicle group, manifesting that the fermented product of the present disclosure is able to facilitate the removal and utilization of blood lactate and to therefore exhibit an anti-fatigue effect. Moreover, after the 10-minute swimming exercise and before the 20-minute rest, a significant dose-dependent effect of the fermented product of the present disclosure on the serum lactate level (p=0.0037) was observed. Further referring to FIG. 3B, after the 20-minute rest, the serum lactate level of each of the 1×, 2×, and 5× groups was significantly lower than that of the vehicle group, revealing that the fermented product of the present disclosure is able to further facilitate the removal and utilization of blood lactate and to therefore exhibit an anti-fatigue effect during the rest after exercise. In addition, after the 20-minute rest, a significant dose-dependent effect of the fermented product of the present disclosure on the serum lactate level (p<0.0001) was noted.

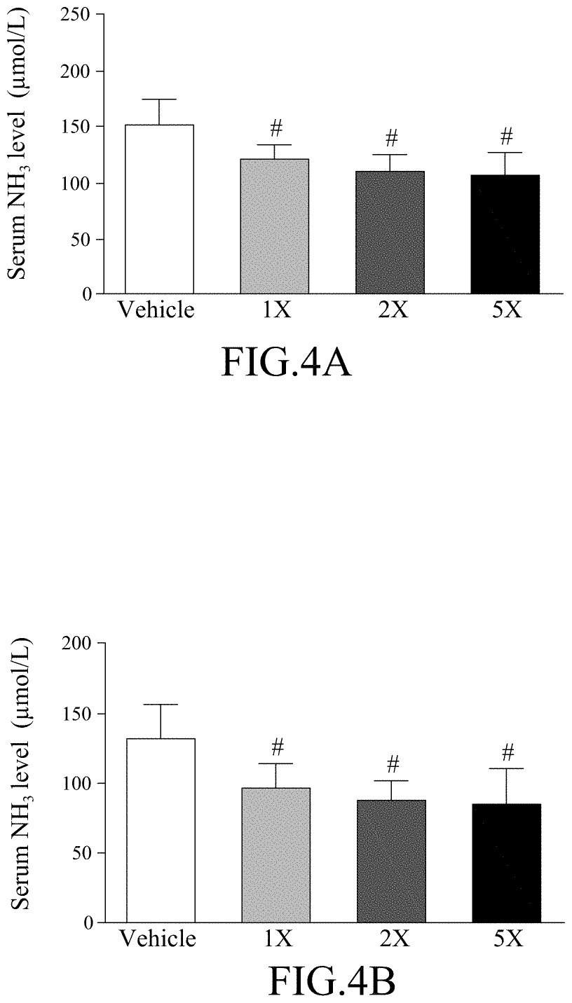

Referring to FIG. 4A, after the 10-minute swimming exercise, the serum ammonia level of the 1×, 2×, and 5× groups was significantly lower than that of the vehicle group, indicating that the fermented product of the present disclosure is able to facilitate reduction of accumulation of blood ammonia and to therefore exhibit an anti-fatigue effect. Moreover, after the 10-minute swimming exercise and before the 20-minute rest, a significant dose-dependent effect of the fermented product of the present disclosure on the serum ammonia level (p<0.0001) was observed. Further referring to FIG. 4B, after the 20-minute rest, the serum ammonia level of each of the 1×, 2×, and 5× groups was significantly lower than that of the vehicle group, indicating that the fermented product of the present disclosure is able to further facilitate reduction of accumulation of blood ammonia and to therefore exhibit an anti-fatigue effect during the rest after exercise. Furthermore, after the 20-minute rest, a significant dose-dependent effect of the fermented product of the present disclosure on the serum ammonia level (p<0.0001) was noted.

In view of the foregoing, the fermented product of the present disclosure can reduce physical fatigue after a short exercise and facilitate post-exercise recovery.

No significant difference was observed on the serum glucose level among the vehicle, 1×, 2×, and 5× groups after the 10-minute swimming test and before the 20-minute rest, and after the 20-minute rest. Therefore, the fermented product of the present disclosure can serve as a satisfactory energy source.

### D-2. 90-Minute Swimming Exercise and 60-Minute Rest

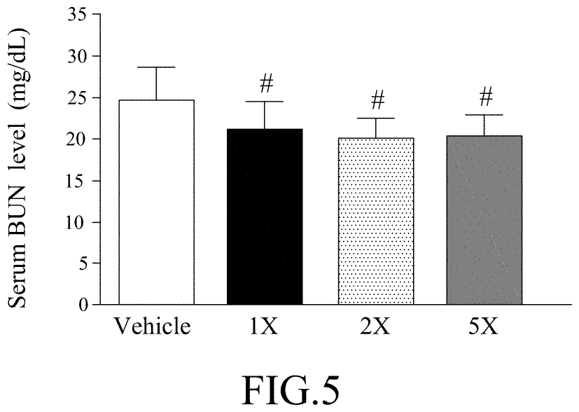

Referring to FIG. 5A, after the 90-minute swimming exercise and the 60-minute rest, the serum BUN level of each of the 1×, 2×, and 5× groups was significantly lower than that of the vehicle group, manifesting that the fermented product of the present disclosure can reduce BUN in blood and hence exhibit an anti-fatigue effect. Furthermore, after the 90-minute swimming exercise and the 60-minute rest, a significant dose-dependent effect of the fermented product of the present disclosure on the serum BUN level (p=0.0301) was observed.

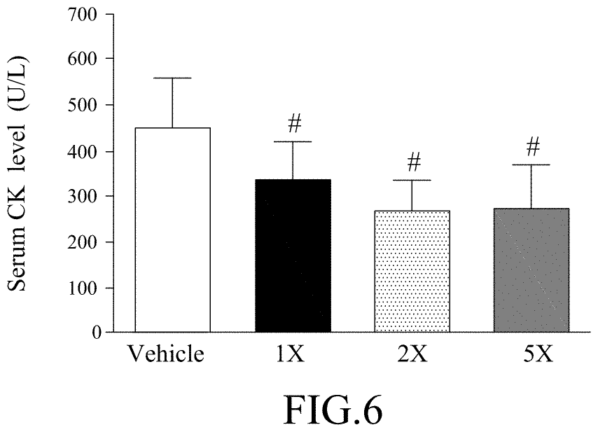

Referring to FIG. 6, after the 90-minute swimming exercise and the 60-minute rest, the serum CK level of each of the 1×, 2×, and 5× groups was significantly lower than that of the vehicle group, revealing that the fermented product of the present disclosure can reduce CK in blood, and hence can provide an anti-fatigue effect and prevent muscle from injury. In addition, after the 90-minute swimming exercise and the 60-minute rest, a significant dose-dependent effect of the fermented product of the present disclosure on the serum CK level (p<0.0001) was observed.

In view of the foregoing, the fermented product of the present disclosure is able to relieve physical fatigue after a long exercise and to hence facilitate post-exercise recovery.

E. Weight Measurement of Tissues and Organs, Glycogen Content Determination, Histological Staining, Assessment of Biochemical Indices, and Analysis of Gut Microbiota after Sacrifice of Test Animals

On Day 36, the final body weight of the mice was recorded. All the mice were fasted for 8 hours, and were subsequently sacrificed by virtue of 95% CO₂ asphyxiation. After the sacrifice of the mice, the following experiments were conducted.

### E-1. Measurement of Tissue and Organ Weights

The liver, kidney, epididymal fat pad (EFP), heart, lung, muscles (including gastrocnemius and soleus muscles in the back part of the lower legs), and brown adipose tissue (BAT) of the respective mouse were excised and weighed, so as to investigate whether the fermented product of the present disclosure has any adverse nutritional effect on these tissues and organs. The data obtained were subjected to statistical analysis according to the method described in section 1 of General Procedures.

### E-2. Determination of Glycogen Content

The liver and muscles of the respective mouse obtained in section E-1 of this example were subjected to determination of glycogen content generally according to the method described in Huang, C. C. et al. (2012), Evid. Based Complement. Altern. Med., 2012:364741. The data obtained were subjected to statistical analysis according to the method described in section 1 of General Procedures.

### E-3. Histological Staining

The liver, kidney, EFP, heart, lung, muscles, and BAT of the respective mouse obtained in section E-1 of this example were subjected to histological staining as follows. The tissue samples were respectively collected from the aforesaid organs and tissues, and were subjected to fixation using 10% formalin. After the formalin fixation, each of the tissue samples was embedded in paraffin, and was cut into a 4-μm-thick slice for morphological and pathological evaluation. The thus obtained tissue section was then stained with hematoxylin and eosin, and was observed under a light microscope equipped with a CCD camera (BX-51, Olympus, Tokyo, Japan) at 200× or 100× magnification.

### E-4. Assessment of Biochemical Indices

Blood was collected from the respective mouse through cardiac puncture, followed by centrifugation. The resulting supernatant, which was serum, was collected. The levels of aspartate aminotransferase (AST), alanine aminotransferase (ALT), albumin, creatinine, lactate dehydrogenase (LDH), CK, total protein (TP), glucose, total cholesterol (TC), and triacylglycerol (TG) in the serum collected were assessed using the autoanalyzer applied in section D of this example. The data obtained were subjected to statistical analysis according to the method described in section 1 of General Procedures.

### E-5 Analysis of Gut Microbiota Composition

A cecum sample was collected from the respective mouse, and was immediately stored at −80° C. for bacterial DNA extraction. Bacterial DNA extraction was conducted according to the cetyltrimethylammonium bromide/sodium dodecyl sulfate (CTAB/SDS) method commonly used in the art. The extracted genomic DNA was stored at −80° C., and was then subjected to 16S rRNA sequencing as follows.

The hypervariable V3-V4 region of the bacterial 16S rRNA gene was amplified from the extracted genomic DNA via polymerase chain reaction (PCR) using bar-coded universal primers 341F (a forward primer; SEQ ID NO: 1) and 806R (a reverse primer; SEQ ID NO: 2). DNA concentration and purity were monitored on 1% agarose gel. Library construction and sequencing of amplicon DNA samples were performed by BIOTOOLS Co., Ltd (New Taipei City, Taiwan). A pair-end library (insert size of 450-470 bp for each sample) was constructed using TruSeq DNA PCR-Free Sample Preparation Kit (Illumina, San Diego, Calif., USA), and high-throughput sequencing was performed on an Illumina HiSeq2500 platform.

The data obtained were subjected to principal coordinate analysis via Bray-Curtis distance measure, phylum analysis, and cladogram analysis via linear discriminant analysis effect size (LEfSe).

### Results:

### E-1. Measurement of Tissue and Organ Weights

Among the vehicle, 1×, 2×, and 5× groups, no significant difference was observed on the initial body weight, final body weight, food intake, and water intake (data not shown). Furthermore, among the vehicle, 1×, 2×, and 5× groups, no significant difference was observed on the weights of the liver, kidney, EFP, heart, and lung, such that the fermented product of the present disclosure has no adverse nutritional effect on the organs and tissues (data not shown).

However, as shown in Table 1 below, the weights of muscles and BAT regarding each of the 1×, 2×, and 5× groups were significantly greater than those regarding the vehicle group, respectively, indicating that the fermented product of the present disclosure can increase the muscles and BAT and hence can improve the strength and fat burning.

TABLE 1

| | Vehicle | | | |
|---|---|---|---|---|
| | group | 1X group | 2X group | 5X group |
| Muscle | 0.36 ± 0.03 | 0.39 ± 0.02^{#} | 0.39 ± 0.02^{#} | 0.39 ± 0.02^{#} |
| weight | | | | |
| (g) | | | | |
| BAT | 0.09 ± 0.02 | 0.12 ± 0.02^{#} | 0.11 ± 0.02^{#} | 0.11 ± 0.01^{#} |
| weight | | | | |
| (g) | | | | |

The symbol “#” represents p < 0.05 (compared with the vehicle group).

### E-2. Determination of Glycogen Content

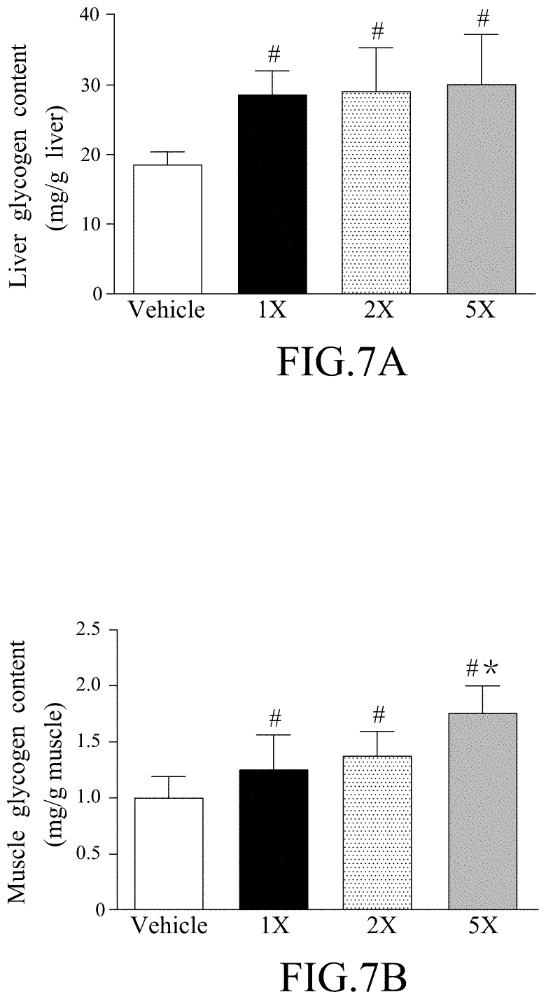

Referring to FIG. 7A, the liver glycogen content of each of the 1×, 2×, and 5× groups was significantly higher than that of the vehicle group, manifesting that the fermented product of the present disclosure is able to enhance the liver glycogen content and hence to exhibit an anti-fatigue effect and to further improve physical endurance. In addition, a significant dose-dependent effect of the fermented product of the present disclosure on the liver glycogen content (p=0.0004) was observed.

Referring to FIG. 7B, the muscle glycogen content of each of the 1×, 2×, and 5× groups was significantly higher than that of the vehicle group, revealing that the fermented product of the present disclosure can enhance the muscle glycogen content, and hence can exhibit an anti-fatigue effect and further improve physical endurance. Moreover, a significant dose-dependent effect of the fermented product of the present disclosure on the muscle glycogen content (p<0.0001) was observed.

In view of the foregoing, the fermented product of the present disclosure is capable of reducing physical fatigue and improving physical endurance.

### E-3. Histological Staining

The histological observations of the liver, muscles, heart, kidney, lung, EFP, and BAT regarding the 1×, 2×, and 5× groups did not differ from those regarding the vehicle group (data not shown). No clinical signs of toxicity were observed after the administration of the fermented product of the present disclosure, indicating that such fermented product is safe, particularly in terms of various dosages applied.

### E-4. Assessment of Biochemical Indices

As shown in Table 2 below, the ALT and CK levels of the 1×, 2×, and 5× groups were significantly lower than those of the vehicle group, indicating that the fermented product of the present disclosure can reduce ALT and CK in blood (the reduction of ALT in blood means no damage to the liver, and the reduction of CK in blood signifies an anti-fatigue effect). Other biochemical indices, including AST, albumin, creatinine, LDH, TP, glucose, TC, and TG, did not differ among the four groups (data not shown), such that the fermented product of the present disclosure is safe, particularly in terms of various dosages applied.

TABLE 2

| | Vehicle | | | |
|---|---|---|---|---|
| | group | 1X group | 2X group | 5X group |
| Serum ALT | 45 ± 19 | 37 ± 12 | 30 ± 6^{#} | 30 ± 8^{#} |
| level | | | | |
| (U/L) | | | | |
| Serum CK | 392 ± 106 | 298 ± 73^{#} | 271 ± 54^{#} | 276 ± 88^{#} |
| level | | | | |
| (U/L) | | | | |

The symbol “#” represents p < 0.05 (compared with the vehicle group).

### E-5 Analysis of Gut Microbiota Composition

Based on the result of the principal coordinate analysis (data not shown), it was found that the vehicle, 1×, 2×, and 5× groups clustered into relatively distinct groups, thus suggesting that the fermented product of the present disclosure can significantly alter the gut microbial populations. Furthermore, at the phylum level, the overall composition of the gut microbiome in the mice of the vehicle, 1×, 2×, and 5× groups was dominated by the phyla Firmicutes (65% for the vehicle group, 69% for the 1× group, 51% for the 2× group, and 57% for the 5× group) and Bacteroidetes (28% for the vehicle group, 25% for the 1× group, 43% for the 2× group, and 39% for the 5× group). Even though the gut microbiotas of the four groups were dominated by Firmicutes and Bacteroidetes (together accounting for approximately 90%), the 2× and 5× groups had a reduced proportion of Firmicutes and an increased proportion of Bacteroidetes. Due to the its ability to increase Bacteroidetes, which is associated with increased expression of proteins involved in the catabolism of branched-chain amino acids and the increased production of short-chain fatty acid (SCFA)(associated with inflammation reduction, satiety enhancement, and overall metabolic effects), the fermented product of the present disclosure, when used in an sufficient amount, may be effective in reducing inflammation, increasing satiety, and providing positive metabolic effects.

In addition, the Firmicutes/Bacteroidetes (F/B) ratios of the 5× and 2× groups (1.46 and 1.19, respectively) were both lower than those of the 1× and vehicle groups (2.76 and 2.32, respectively). The reduction of the F/B ratio suggests that the fermented product of the present disclosure, when used in a sufficient amount, may provide satisfactory prebiotics and probiotics.

The results of the cladogram analysis are described below. Regarding the result of the comparison of gut microbiota compositions between the vehicle and 1× groups (data not shown), the LEfSe indicated that the number of bacteria from the family Ruminococcaceae (which is associated with the maintenance of gut health) was higher in the 1× group than in the vehicle group. Furthermore, regarding the result of the comparison of gut microbiota compositions between the vehicle and 2× groups (data not shown), it was found that the proportion of each of Bacteroidales (which is known to provide beneficial properties to the host) and Bacteroidia was higher in the 2× group than in the vehicle group, whereas the proportion of each of Clostridiales and Clostridia was higher in the vehicle group than in the 2× group. Lastly, the result of the comparison of gut microbiota compositions between the vehicle and 5× groups (data not shown) showed that the 5× group had higher proportions of Rikenellaceae, Bacteroidales, and Bacteroidia compared to the vehicle group, whereas the vehicle group had a higher proportion of Clostridia compared to the 5× group. In view of the foregoing, the fermented product of the present disclosure can modify the gut microbiota composition, thereby contributing to the metabolic networks that reduce physical fatigue and improve exercise performance.

All patents and references cited in this specification are incorporated herein in their entirety as reference. Where there is conflict, the descriptions in this case, including the definitions, shall prevail.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A starter culture for preparing a fermented product, comprising:
a mixture of the following five lactic acid bacteria strains deposited at Deutsche Sammlung von Mikroorganismen und Zellkulturen GmbH: Lactobacillus fermentum strain LF26 with Accession No. DSM 32784, Lactobacillus helveticus strain LH43 with Accession No. DSM 32787, Lactobacillus paracasei strain LPC12 with Accession No. DSM 32785, Lactobacillus rhamnosus strain LRH10 with Accession No. DSM 32786, and Streptococcus thermophilus strain ST30 with Accession No. DSM 32788.

2. The starter culture as claimed in claim 1, which is in a state selected from the group consisting of a liquid, a paste, a semi-solid, a solid, and combinations thereof.

3. A process for preparing a fermented product, comprising:
subjecting a fermentable material to a fermentation treatment with a starter culture as claimed in claim 1.

4. The process as claimed in claim 3, wherein the fermentable material is selected from the group consisting of a dairy material, a soybean material, a rice material, a nut material, a coconut material, a fruit material, a beer wort material, a ginger material, and combinations thereof.

5. The process as claimed in claim 4, wherein the fermentable material is a dairy material.

6. The process as claimed in claim 5, wherein the fermentable material is selected from the group consisting of milk, whey, fermented milk, a lactic acid bacterium drink, skim milk, powdered skim milk, prepared powdered milk, powdered milk, concentrated milk, concentrated skim milk, reconstituted skim milk, condensed milk, condensed skim milk, sweetened condensed milk, sweetened condensed skim milk, and combinations thereof.

7. The process as claimed in claim 6, wherein the fermentable material is reconstituted skim milk.

8. The process as claimed in claim 3, further comprising conducting a dehydration treatment after the fermentation treatment.

9. The process as claimed in claim 8, wherein the dehydration treatment is selected from the group consisting of freeze-drying, fluidized bed drying, spray bed drying, drying under reduced pressure, hot-air drying, fluidized bed granulation, and combinations thereof.

10. The process as claimed in claim 9, wherein the dehydration treatment is freeze-drying.

11. The process as claimed in claim 3, wherein the fermentation treatment is conducted at 30° C. to 43° C. for 8 to 24 hours.

12. A fermented product which is prepared by a process as claimed in claim 3.

13. The fermented product as claimed in claim 12, which is in a form selected from the group consisting of a liquid, a paste, a semi-solid, a solid, and combinations thereof.

14. The fermented product as claimed in claim 12, which is in a form selected from the group consisting of a frozen from, a dried form, and a freeze-dried form.

15. A method for reducing fatigue, comprising:
administering to a subject a fermented product as claimed in claim 12.

16. The method as claimed in claim 15, wherein the fermented product is administered to the subject at a daily dosage ranging from 0.17 to 0.875 g/Kg body weight of the subject.

17. A method for improving exercise performance, comprising:
administering to a subject a fermented product as claimed in claim 12.

18. The method as claimed in claim 17, wherein the fermented product is administered to the subject at a daily dosage ranging from 0.17 to 0.875 g/Kg body weight of the subject.

19. A method for modifying gut microbiota, comprising:
administering to a subject a fermented product as claimed in claim 12.

20. The method as claimed in claim 19, wherein the fermented product is administered to the subject at a daily dosage ranging from 0.17 to 0.875 g/Kg body weight of the subject.


SEQUENCE LISTING (2 sequences)

SEQ ID NO: 1 - DNA, 17 bp, Artificial Sequence
  Forward primer 341F for amplifying bacterial 16S rRNA
cctaygggrbgcascag

SEQ ID NO: 2 - DNA, 20 bp, Artificial Sequence
  Reverse primer 806R for amplifying bacterial 16S rRNA
  misc_feature (8)..(9): n is a, c, g, or t
ggactacnngggtatctaat